(19) United States
(12) Patent Application Publication
(10) Pub. No.: US 2006/0243563 A1
(43) Pub. Date: Nov. 2, 2006

(54) Adjustable transfer unit which is used to transfer aligned, upright objects from a first conveyor to a second conveyor

(76) Inventor: Jaime Marti Sala, Barcelona (ES)

Correspondence Address: RATNERPRESTIA, P O BOX 980, VALLEY FORGE, PA, 19482-0980, US

(21) Appl. No.: 10/535,539

(22) PCT Filed: Nov. 18, 2003
(86) PCT No.: PCT/ES03/00586

§ 371 Date: May 15, 2006

(30) Foreign Application Priority Data
Nov. 18, 2002 (ES) U200202924

(51) Int. Cl. B65G 47/22; B65G 47/52

(52) U.S. Cl. 198/723; 198/457.05; 198/610; 198/861.1

(57) ABSTRACT

Adjustable transfer unit for transferring upright and aligned articles from a first to a second conveyor. Comprising a rotary wheel with radial blades, a curved support track, between a delivery end of an inlet conveyor and a reception end of an outlet conveyor, with conveyor being adapted to convey articles upright on their base on a surface and said conveyor is overhead to convey hanging articles, with support track of the transfer unit being connected to vertical movement means for adapting the vertical distance between support track and lifting guides of outlet conveyor to different height articles with said configuration.

This invention relates to an adjustable transfer unit designed for transferring upright and aligned articles from a first to a second conveyor, and more particularly for transferring articles that are upright on their base on an inlet transfer surface, provided, for example, at the outlet of an adjustable positioning machine, and an overhead outlet conveyor, adapted to convey the articles hanging from a projecting configuration provided on a top part thereof along lifting guides.

Transfer units that have a thrusting wheel provided with a plurality of radial blades along its circumference and which is driven in a rotary manner to transfer articles, such as empty, lightweight containers, from a first inlet conveyor, extending in one direction, to a second outlet conveyor, extending in a second direction, have been known for a long time. This type of transfer units comprise, in addition to the said thrusting wheel with its corresponding radial blades, a curved support track, arranged below said radial blades and extending at least between a delivery end of the first inlet conveyor and a reception end of the second outlet conveyor, and rail means arranged along at least one part of said support track. The thrusting wheel is connected to driving means provided to make it rotate at a regular speed in one direction, and thereby the radial blades move around and receive, one by one, the articles coming from said delivery end of the inlet conveyor, push said articles moving them along the support track and deliver them to the said reception end of the outlet conveyor.

Generally, both the first inlet conveyor and the second outlet conveyor are basic conveyors, in other words, of the type that are adapted to convey articles, upright on their base, on a transfer surface, such as a continuous mobile conveyor belt, or a stationary surface along which the articles are dragged by mobile pushing elements. Therefore, the support track of the transfer unit is substantially level both with a transfer surface of the inlet conveyor and a transfer surface of the outlet conveyor and, consequently, the transfer unit is useful for articles of different heights.

In some applications it is desirable that the outlet conveyor is an overhead conveyor, of a known type provided with lifting guides along which the articles are conveyed hanging from a projecting configuration on a top part thereof, which configuration, in the case of lightweight containers, is an annular flange provided on the base of the neck thereof. The dimensions of said neck and flange are standard and do not vary with the different sizes of the containers. However, when the inlet conveyor is a conveyor and the outlet conveyor is an overhead conveyor, there is the drawback in that the said lifting guides of the overhead conveyor must be at a certain height from the support track of the transfer unit, according to the height of the article and, therefore, the transfer unit is only useful for articles of this one size.

It is also known that said transfer surface of the first conveyor is a stationary transfer surface provided at the outlet of a rotary article positioning machine. In this case, the transfer unit receives the upright and aligned articles from a transfer surface associated with deflecting means that divert the articles from a stationary annular support plane arranged beneath the open bottom walls of drop chutes joined to a rotary structure of the machine, on which plane the articles are pushed in the upright position by radial walls of the said drop chutes.

The machines of this type are well known and comprise an upper hopper in which the articles are received in a disorderly fashion in bulk, with a rotary bottom wall associated with said rotary structure and housings provided along the circumference of said bottom wall and also associated with the rotary structure. These housings are angled tangentially and each one has an open bottom wall placed above an open widened mouth of a corresponding drop chute. Radial walls of said housings drag the articles therein in a horizontal position onto another higher stationary plane, arranged between said open bottom walls of the housings and said open mouths of the drop chutes. The said radial walls of the housings include end stops and/or supports for supporting a different final configuration of the articles, which, in the case of containers, is the neck thereof, irrespective of the front or rear position of said different final configuration inside the housing, and the said higher stationary plane includes an interruption in one section of its circumference where articles travelling in the housings fall upright into their corresponding drop chute. Stationary deflecting means are provided to divert the articles travelling upright in the drop chutes towards an outlet support surface, which can be, for example, said transfer surface at the entrance of said thrusting wheel.

International patent application PCT/ES02/00467, in the name of the current applicant, describes a rotary article positioning machine of the type described above in which both the housings and the drop chutes are adjustable to different size articles and where the said higher stationary plane includes several of said interruptions while the drop chutes include various areas, so that the machine can load two or four articles, depending on the size thereof, in each drop chute during one single turn. This same patent application introduces a transfer unit of the type described above in which the thrusting wheel is made up of first and second circular, coaxial structures, and the radial blades include first radial blades attached to said first circular structure and second radial blades attached to said second circular structure, at predetermined angular separations along their respective circumferences. Adjusting means are provided to adjust the relative angular position between both first and second circular, coaxial structures, and thus adapt the separations between said first and second radial blades to different size articles, according to the size of the articles handled by the positioning machine. However, in this transfer unit the above mentioned problem with the overhead outlet conveyor persists, since it does not include vertical adjustment means for adapting the unit to different height articles.

The object of this invention is to provide an adjustable transfer unit for transferring upright and aligned articles from a first to a second conveyor, provided with vertical adjustment means for adapting the unit to different size articles in order to transfer different size articles from an inlet conveyor, for example, a transfer surface from the outlet of an adjustable rotary positioning machine, to an overhead outlet conveyor.

The preceding object is achieved, according to the principles of this invention, by providing an adjustable transfer unit for transferring upright and aligned articles from a first to a second conveyor, which includes a thrusting wheel provided with radial blades, a curved support track provided below said radial blades, and railing means along at least one part of said support track. Driving means are adapted to make said thrusting wheel rotate and therefore receive via the radial blades, one by one, the articles coming from a delivery end of said first conveyor, which is an inlet conveyor, push the articles by moving them along the support track and deliver the articles to a reception end of said second conveyor, which is an overhead outlet conveyor. The support track extends at least between said delivery and reception ends of the inlet and outlet conveyors, which are respectively of the types described above. The transfer unit support track is associated with vertical movement means that can be driven to adapt the vertical distance between the support track and said lifting guides of the outlet conveyor to different size articles. The lifting guides of the overhead outlet conveyor are placed at a suitable height from the transfer surface of the inlet conveyor for small size articles, and the transfer unit support track can be moved by said vertical movement means between a top position suitable for said small size articles, in which the support track is substantially level with said transfer surface of the inlet conveyor, and one or more lower positions suitable for medium or large size articles, in which the support track is at a lower level than said transfer surface of the inlet conveyor, and at suitable vertical distances from the lifting guides of the overhead outlet conveyor respectively for said medium or large size articles. In said one or various lower positions, the articles pass from the transfer surface to the support track placed at a lower level by falling by their own weight while said articles are moved inside areas delimited by the radial blades, said railing means, and inner wall means joined to the thrusting wheel. Advantageously, this arrangement of the vertical adjustment means combines with means for adjusting the separation distances between the radial blades on the thrusting wheel, that consist of first and second circular coaxial structures, with respective first and second radial blades attached thereto at predetermined angular separations alternated along the respective circumferences thereof, and with adjustment means arranged to adjust the relative angular position between both first and second circular, coaxial structures, as described above.

This way, the adjustable transfer unit of this invention includes all the necessary adjustment means for transferring different size articles from, for example, an adjustable positioning machine with multiple areas in the drop chutes, such as the one presented in the referenced International patent application PCT/ES 02/00467, in the name of the current applicant, to the lifting guides of an overhead outlet conveyor, of the type described above.

These and other advantages and characteristics will be more comprehensible from the following detailed description of an embodiment provided with reference to the attached drawings, in which:

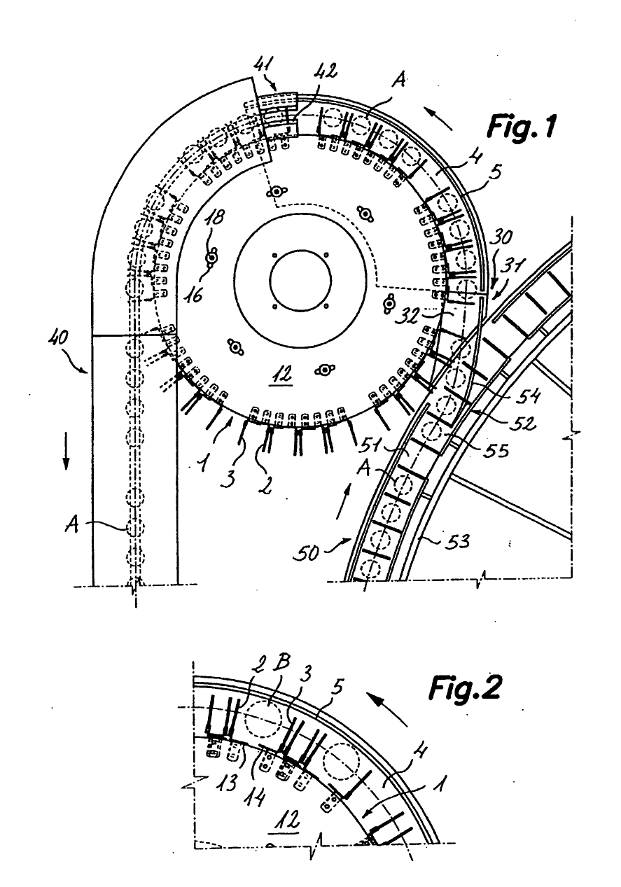

FIG. 1 is a diagrammatic plan view of the transfer unit according to the invention arranged between an inlet conveyor, which is an outlet device from a positioning machine, and an overhead outlet conveyor, with the radial blades of the thrusting wheel adjusted to small size articles;

FIG. 2 is a detail of the transfer unit of FIG. 1 with the radial blades of the thrusting wheel adjusted to large size articles;

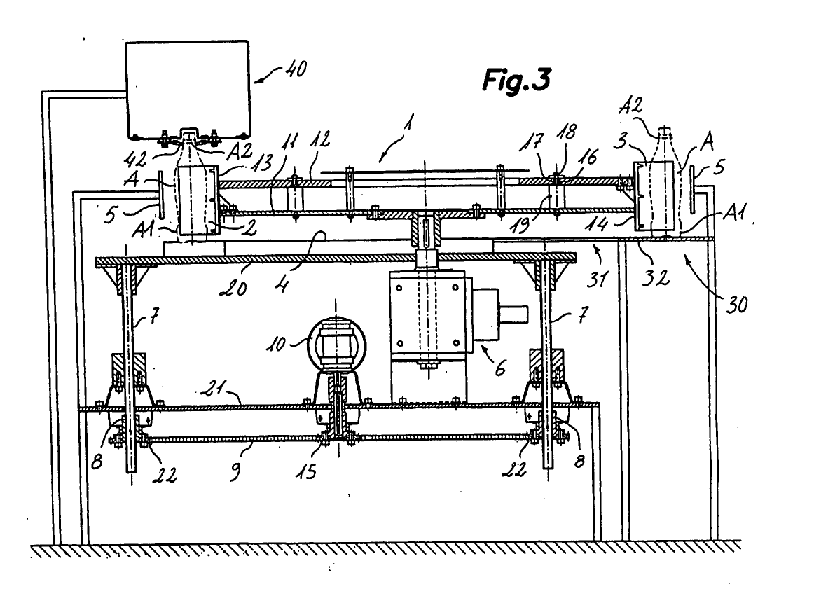

FIG. 3 is a diagrammatic view in section of the transfer unit of this invention arranged between an inlet conveyor and an overhead outlet conveyor, and with the vertical position of the support track adjusted to small size articles; and

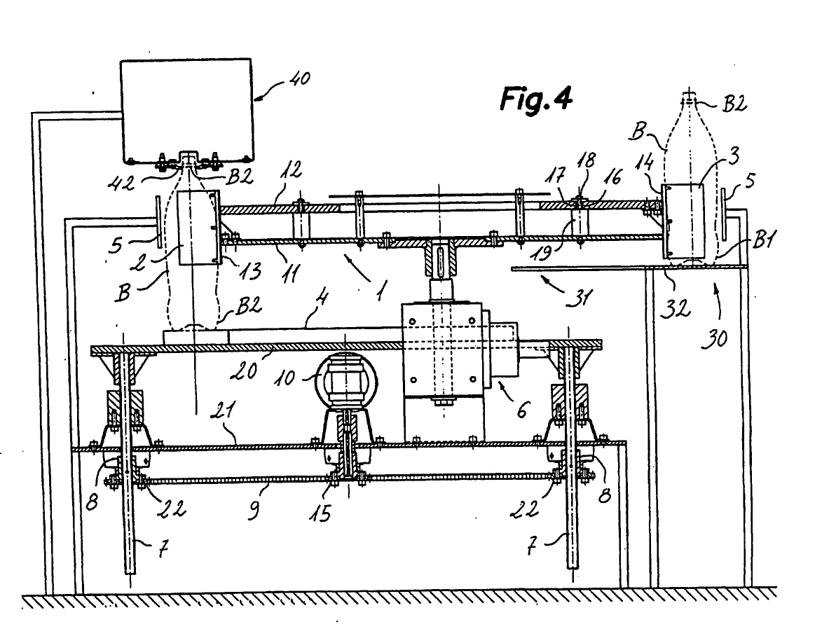

FIG. 4 is a diagrammatic view in section of the proposed transfer unit arranged between an inlet conveyor and an overhead outlet conveyor, and with the vertical position of the support track adjusted to large size articles.

First of all, with reference to FIG. 1, this is a plan view of an adjustable transfer unit of this invention arranged to transfer upright and aligned articles from a first conveyor, or inlet conveyor 30, to a second conveyor, outlet conveyor 40, where said inlet conveyor 30 is a conveyor adapted to convey articles A, B, upright on their bases A1, B1, on a transfer surface 32 (see also FIGS. 3 and 4) and said outlet conveyor 40 is an overhead conveyor adapted to convey articles A, B hanging by a projecting configuration A2, B2 on a top part thereof along lifting guides 42 of the conveyor (see also FIGS. 3 and 4). Articles A, B shown in the figures are empty, lightweight bottle type containers, in which said base A1, B1 is a base or bottom wall of the bottle and said projecting configuration A2, B2 is a flange or annular tab provided at the base of the bottle neck. The dimensions of said neck and said flange are standard and do not vary with the different sizes of the containers A, B. The transfer unit includes a thrusting wheel 1 provided with radial blades 2, 3, a curved support track 4 arranged below said radial blades 2, 3, between a delivery end 31 of said inlet conveyor 30 and a reception end 41 of said outlet conveyor 40, and railing means 5 along at least one part of said support track 4. Driving means 6 are provided to rotate said thrusting wheel 1 and radial blades 2, 3 attached thereto receive, one by one, articles A, B coming from said delivery end 31 of inlet conveyor 30, push them by moving them along support track 4 and deliver them to the said reception end 41 of outlet conveyor 40.

With reference now to FIGS. 3 and 4, support track 4 of the transfer unit is connected to vertical adjustment means 7, 8 that can be driven to adapt the vertical distance between support track 4 and said lifting guides 42 of outlet conveyor 40 to different size articles A, B. Support track 4 can be moved by said vertical movement means 7, 8 between a top position, shown in FIG. 3, suitable for small size articles A, and in which support track 4 is substantially level with said transfer surface 32 of inlet conveyor 30, and at least a lower position, shown in FIG. 4, suitable for medium or large size articles B, and in which support track 4 is at a lower level than said transfer surface 32 of inlet conveyor 30. In this lower position, articles B pass from transfer surface 32 to support track 4 by falling by their own weight as said articles are moved in areas delimited by radial blades 2, 3, said railing means 5, and inner wall means 13, 14 associated with thrusting wheel 1. Said inner wall means 13, 14 include first and second inner wall portions 13, 14 attached respectively to first and second circular, coaxial structures 11, 12 and arranged on opposite sides of the respective first and second radial blades 2, 3 (FIGS. 1 and 2). Said first and second inner wall means 13, 14 are placed at different radial distances from the centre of thrusting wheel 1 so that the former rest at least partially imposed on the others (FIG. 2) when the separations between first and second radial blades 2, 3 are adapted for large size articles B.

Said vertical movement means 7, 8 include at least one pair of driving units each one made up of a vertical sleeve 7 attached to a platform 20 that supports or includes support track 4, and is coupled to a nut 8 mounted in a captive rotary fashion in a fixed support structure 21, which also supports thrusting wheel 1 and railing means 5. Nuts 8 are joined to respective pinion gears or pulleys 22 connected together by means of a flexible traction element 9, such as a chain or belt. This flexible traction element 9 is also passed over a pinion gear or drive pulley 15 connected to a power shaft of driving means 10, so that both vertical sleeves 7 can turn in one direction or another driven by said driving means 10 to vary the vertical position of support track 4. By including suitable vertical guide means (not shown) it would be possible to vary the vertical position of support track 4 using a single vertical sleeve 7 and nut 8 unit. Driving means 10 preferably comprise a reducer unit, although they could also be manually driven, for example, by means of a handle (not shown), since said adjustment of the vertical position of support track 4 is only made every now and again, when the size of the articles to be handled changes.

Thrusting wheel 1 is made up of first and second circular, coaxial structures 11, 12, and radial blades 2, 3 comprise first radial blades 2 attached to said first circular structure 11 and second radial blades 3 attached to said second circular structure 12, at predetermined angular separations alternated along the respective circumferences thereof (see also FIGS. 1 and 2). In the interest of clarity in the drawings, in FIGS. 3 and 4 only one first radial blade 2 is shown attached to the first circular structure 11 and a second radial blade 3 attached to the second circular structure 12 and the railing means 5 are illustrated in a very diagrammatic manner only in front of said first and second radial blades 2 and 3. The afore-mentioned driving means 6 of thrusting wheel 1 include, for example, a reducer unit 6 coupled to the first circular coaxial structure 11, which in turn is joined to the second circular coaxial structure 12 by adjustment and attachment means 16, 17, 18 provided to adjust the relative angular position between both first and second circular, coaxial structures 11, 12 in order to adapt the separations between said first and second radial blades 2, 3 to different size articles A, B and to mutually set both first and second circular coaxial structures 11, 12 in a selected angular position. Said adjustment and attachment means 16, 17, 18 include guide means 16 in the form of elongated openings with a curved trajectory with respect to the centre of thrusting wheel 1 in the second circular coaxial structure 12 and guide followers 17 in the form of studs 17 attached to the first circular coaxial structure 11 and inserted in said elongated openings 16 to move along same. Releasable attachment means 18, in the form of nuts coupled to threads on said studs 17, are provided to block the first and second circular coaxial structures 11, 12 together in the selected angular position. Preferably, studs 17 are arranged in the ends of column shaped separators 19 attached to the first circular coaxial structure 11 and the second circular coaxial structure 12 rests on said separators 19. For a person skilled in the art, it is obvious that an equivalent assembly would be obtained by attaching separators 19 and studs 17 to the second circular structure 12 and providing elongated openings 16 in the fist circular structure 11, and/or coupling driving means 6 of thrusting wheel 1 to the second circular coaxial structure 12.

With reference again to FIGS. 1 and 2, it will be observed that the said predetermined angular separations according to which the first and second radial blades 2, 3 are arranged along the circumferences of their respective first and second circular coaxial structures 11, 12 have empty spaces between groups of four couples of first and second radial blades 2 and 3. This is like this because said transfer surface 32 of delivery end 31 of inlet conveyor 30 is level with a stationary support plane 51 arranged below the open bottom walls of drop chutes 52 associated with a rotary structure 53 of an adjustable rotary machine 50 that positions articles like the one described in the referenced International patent application PCT/ES 02/00467, in the name of the current applicant. In this adjustable rotary machine 50, the articles, once upright and aligned, are pushed along said stationary support plane 51 by walls of said drop chute 52 and diverted towards a support track 4 by stationary deflecting means 54. Drop chutes 52 have multiple compartments 55 of adjustable width for different size articles A, B. When positioning machine 50 is adjusted to handle small size articles A, it is capable of filling four of said small size articles A in compartments 55 of each drop chute 52 during one turn and the angular separations of radial blades 2, 3 are adjusted, as shown in FIG. 1, to receive small size articles A in individual groups of four. When positioning machine 50 is adjusted to handle large size articles B, it is capable of filling two of said large size articles B in compartments 55 of each drop chute 52 during one turn and the angular separations of radial blades 2, 3 are adjusted, as shown in FIG. 2, to receive large size articles B in individual groups of two. Also, driving means 6 rotate thrusting wheel 1 at a speed such that radial blades 2, 3 thereof move at the same tangential speed as drop chutes 52 of rotating structure 53 of said positioning machine 50.

A person skilled in the art will be able to introduce various changes and modifications without departing from the scope of this invention, which is defined by the attached claims.

1. An adjustable transfer unit for transferring upright and aligned articles from a first to a second conveyor, of the type comprising a thrusting wheel driven in a rotary fashion by driving means and having radial blades, a curved support track provided below said radial blades between a delivery end of an inlet conveyor and a reception end of an outlet conveyor, and railing means along at least one part of said support track, characterized in that said inlet conveyor is a conveyor adapted to convey articles upright on their base on a transfer surface and said outlet conveyor is an overhead conveyor adapted to convey articles hanging from a projecting configuration on a top part thereof along lifting guides of the overhead outlet conveyor, with said support track of the transfer unit being connected to vertical movement means that can be driven to adapt the vertical distance between said support track and said lifting guides of the outlet conveyor to articles having said projecting configuration at different heights.

2. The unit, according to claim 1, characterized in that said support track can be moved by said vertical movement means between a top position suitable for small size articles, in which said support track is substantially level with said transfer surface of said inlet conveyor, and at least one lower position suitable for medium or large size articles, in which said support track is at a lower level than said transfer surface of inlet conveyor, with articles passing from transfer surface to said support track by falling by their own weight as they are moved within areas delimited at least by said radial blades and said railing means.

3. The unit, according to claim 2, characterized in that said vertical movement means include at least one unit of a vertical sleeve sand nut.

4. The unit, according to claim 2, characterized in that said vertical movement means include at least one pair of vertical sleeve and nut units connected together by means of a flexible traction element, such as a chain or belt, which flexible traction element is driven by a pinion gear or drive pulley connected to a power shaft of driving means to rotate said vertical sleeves in one direction or another.

5. The unit, according to claim 4, characterized in that said driving means include a reducer unit.

6. The unit, according to claim 1, characterized in that said thrusting wheel is made up of first and second circular structures coaxial, and said radial blades include first radial blades attached to said first circular structure and second radial blades attached to said second circular structure, at predetermined angular separations along their respective circumferences, with adjustment and attachment means being provided to adjust the relative angular position between both said first and second circular coaxial structures in order to adapt the separations between said first and second radial blades to different size articles.

7. The unit, according to claim 6, characterized in that it includes first and second inner wall parts attached respectively to said first and second circular coaxial structures and arranged on opposite sides of respective said first and second radial blades, with said first and second inner wall parts being placed at different radial distances from the centre of said thrusting wheel so that the former can rest at least partially superimposed on the latter when the separations between said first and second radial blades are reduced.

8. The unit, according to claim 6, characterized in that said driving means of said thrusting wheel include a reducer unit coupled to one of said first or second circular coaxial structures which in turn is joined to the other of said first or second circular coaxial structures by means of adjustment and attachment means.

9. The unit, according to claim 6, characterized in that said adjustment and attachment means include guide means of curved trajectory with respect to the centre of thrusting wheel in one of said first or second circular coaxial structures, guide followers being attached to the other of said first or second circular coaxial structures and arranged to move along said guide means, and releasable attachment means for blocking first and second circular coaxial structures together in a selected angular position.

10. The unit, according to claim 9, characterized in that said guide followers are provided at the ends of separators attached to one of said first or second circular coaxial structures, with the other of said first or second circular coaxial structures resting on said separators.

11. The unit, according to claim 1, characterized in that a delivery end of said inlet conveyor is made up of a transfer surface level with a stationary support plane arranged below the open bottom walls of drop chutes associated with a rotary structure of an article positioning machine, with said articles being pushed along said stationary support plane by walls of said drop chutes and diverted towards said transfer surface by stationary deflecting means.

12. The unit, according to claim 6, characterized in that a delivery end of said inlet conveyor is made up of a transfer surface level with a stationary support plane arranged below the open bottom walls of drop chutes associated with a rotary structure of an adjustable article positioning machine, with said articles being pushed along said stationary support plane by walls of said drop chutes and diverted towards said transfer surface by stationary deflecting means, with drop chutes of said adjustable positioning machine having multiple compartments of adjustable width for different size articles, with the adjustable positioning machine being capable of filling several of said compartments of each drop chute with upright articles during each turn of said rotary structure.

13. The unit, according to claim 12, characterized in that said predetermined angular separations between said radial blades along the respective said first and second circular coaxial structures are adapted to the separations between said drop chutes in the rotary structure of the adjustable positioning machine and can be adjusted according to the adjustment of said compartments in said drop chutes.

14. The unit, according to claim 11, characterized in that said driving means rotate said thrusting wheel at a speed such that the radial blades thereof move at the same tangential speed as the drop chutes of rotary structure of said adjustable positioning machine.
